(19) United States
(12) Patent Application Publication
(10) Pub. No.: US 2002/0079710 A1
(43) Pub. Date: Jun. 27, 2002

(54) Shaped part and a method of forming same

(76) Inventors: Jurgen Wieser, Kaufering (DE); Heinz Bisping, Augsburg (DE); Claudia Zimmerer, Augsburg (DE); Peter Scheffler, Nersingen-Strass (DE); Erich Daigeler, Waal (DE); Alois Kolbl, Buchloe (DE)

Correspondence Address: David Toren, SIDLEY AUSTIN BROWN & WOOD LLP, 875 Third Avenue, New York, NY, 10022, US

(21) Appl. No.: 10/021,791

(22) Filed: Nov. 30, 2001

(30) Foreign Application Priority Data
Dec. 22, 2000 (DE) 100 64 590.9

(51) Int. Cl. B29D 1/00; E05C 17/02

(52) U.S. Cl. 292/305; 264/318

(57) ABSTRACT

A shaped part having a hollow cylindrical body (1) having at least two longitudinal slots (5) extending over a larger portion of a longitudinal extent of the hollow cylindrical body (1) and open at one of end surfaces of the hollow cylindrical body (1), and a circumferential undercut formed in an inner wall (3) of the hollow cylindrical body (1) in its longitudinal region intersected by the longitudinal slots (5), spaced from the one end surface, and having a flank (9) tapering toward the one end.

### BACKGROUND OF THE INVENTION

1. Field of the Invention

The present invention relates to a shaped part to be produced by injection molding and, in particular, to a shaped part to be used as a fastening part and having a hollow cylindrical body having at least two longitudinal slots extending over a larger portion of a longitudinal extent of the hollow cylindrical body and open at one of the end surfaces of the hollow cylindrical body, and a circumferential undercut formed in an inner wall of the hollow cylindrical body. The present invention also relates to a method of forming such a shaped part.

2. Description of the Prior Art

Shaped parts of the type described above are primarily used as components of fastening systems, e.g., as expansion members of so-called plastic dowels. For economical reasons, such shaped parts are often produced by injection-molding. Naturally, the shaped parts of the type described above find other uses than that of a component of a fastening system.

German Publication DE-A1-4004 550 discloses a plastic dowel including a hollow cylindrical expansion body expandable by an expansion element. As the expansion element, usually, a screw can be used. The expansion body has a plurality of undercuts formed in its inner wall. The undercuts function as an inner thread with which the screw cooperate. The screw expands the expansion body upon being screwed thereinto. The disclosed shaped part is formed of two base bodies, with the separation plane passing through the central axis of the inner thread. The drawback of the disclosed shaped part consists in its high manufacturing costs connected with the formation of the part of two bodies.

European Publication EP-B1-560 517 discloses a shaped part, in particular, an all-purpose dowel including a substantially cylindrical hollow body with a plurality of circumferential undercuts formed in the body inner wall. In order to emboss the undercuts in the inner wall of the dowel, the shaped part has, in its axial projection region, a plurality of openings leading into the interior of the shaped part. During the manufacturing process, a plurality of pins extends through the openings into the inner space, forming the undercuts in the inner wall of the part. The drawback of this shaped part consists in that its manufacture is rather complicated, and, therefore, for its manufacture expensive tools are needed.

Accordingly, an object of the present invention is to provide a shaped part with a circumferential undercut formed in the inner wall and which is to be produced by injection-molding.

Another object of the present invention is to provide an economical manufacturing process for producing the shaped part.

### SUMMARY OF THE INVENTION

These and other objects of the present invention, which will become apparent hereinafter, are achieved by providing a shaped part the hollow body of which has at least two longitudinal slots extending over a larger portion of a longitudinal extent of the hollow cylindrical body and open at one of end surfaces of the hollow cylindrical body, and a circumferential undercut formed in an inner wall of the hollow cylindrical body in its longitudinal region intersected by the longitudinal slots and spaced from the end surface of the hollow cylindrical body at which the slots open, with the undercut having a flank tapering toward the one end surface; and by providing a method including filling a space between an outer mold and chaplet with a material, thereafter, removing the outer mold, and displacing a stripping ring, which is provided at the one end side of the hollow cylindrical body and which surrounds the chaplet, relative to the chaplet in such a way that the formed shaped part is stripped from the chaplet.

According to the present invention, the expansion tabs are formed by the longitudinal slots, together with the undercut. The radially resiliently expandable expansion tabs permit to pull out an element engaging in the undercut at the end of the shaped part at which the slot are open. However, if a load is applied to an end of the engaging element remote from the undercut, sliding of the engaging element from the undercut is not possible.

Advantageously, the length of the longitudinal slots amounts to at least five times of their width, which results in reduction in the loss of material caused by the formation of the slots. In particular when the shaped part is used as a dowel, the reduction of the slot width leads to an increase of the contact surface of the dowel, which permits the dowel to withstand high loads.

In the preferred embodiment of the present invention, the length of the longitudinal slots corresponds at least to the inner diameter of the cylindrical body. This permits to substantially reduce the load applied to the shaped part during expansion of the tabs. The greater is the length of the longitudinal slot, the smaller is the radial deflection and thereby the material stress, in particular in the region of the undercut.

Advantageously, the distance of the undercut from the end surface of the body, at which the slots open, corresponds to 0.25-0.75 times of the length of the longitudinal slots. Providing the undercut at this distance permits to insure an optimal deflection of the expansion tabs.

Advantageously, the shaped part is formed of a high-strength plastic material to insure a sufficient high stability of the part even when large loads are applied thereto.

The inventive process insures an economical manufacturing of the inventive shaped part. By changing the outer profile of the chaplet, differently shaped undercuts can be formed in the inner wall of the part. Stripping insures a quick removal of the part from the chaplet. The reduction of the manufacturing cycle also leads to an economical manufacturing of the inventive shaped part, which is particularly important in mass production of the parts such as, e.g., fastening components. Also contributes to the economical manufacturing the fact that the undercut is not formed in a separate step.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a cross-sectional view of a shaped part according to the present invention at an increased scale;

FIG. 2 a cross-sectional view of the shaped part shown in FIG. 1 with an inserted chaplet before the ejection; and

FIG. 3 A cross-sectional view of the shaped part shown in FIG. 1 with the inserted chaplet after the part has been ejected.

### DETAILED DESCRIPTION OF THE PREFERRED EMBODIMENT

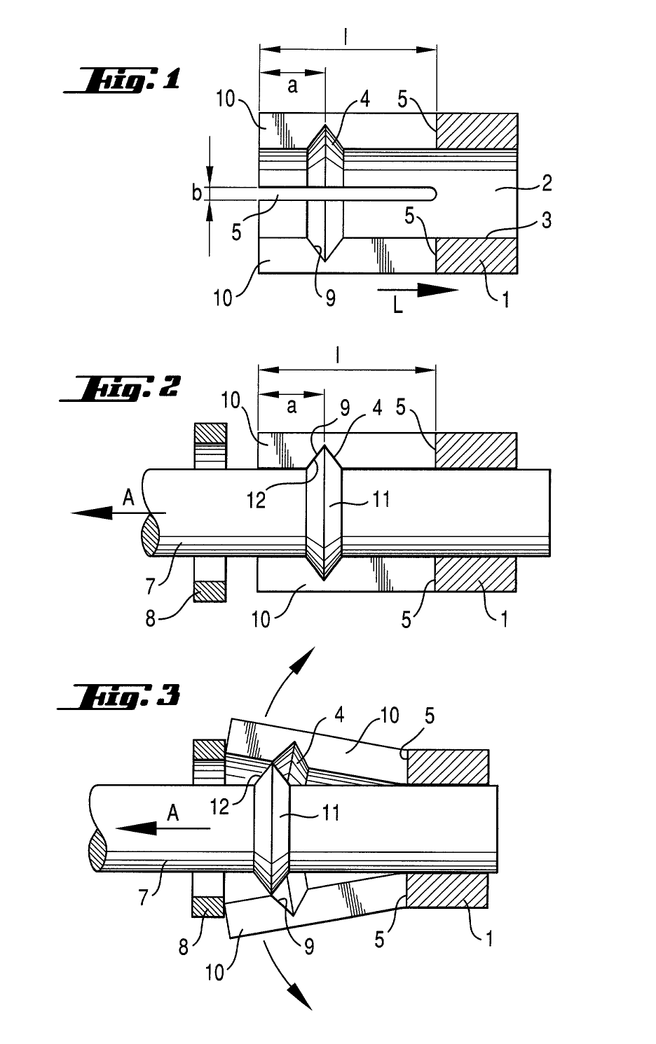

A shaped part according to the present invention which is shown in FIGS. 1-3, has a hollow cylindrical body 1 having a bore 2 and an undercut 4 formed in the inner wall 3. A plurality of slots 5 extend over a greater portion of a longitudinal extent of the body 1 in a longitudinal direction L. The undercut 4 is formed between the radial projection regions of the longitudinal ends of the slots 5. The undercut 4 is formed closer to the open ends of the longitudinal slots 5 and is provided with narrowing flanks 9. The longitudinal slots 5, together with the undercut 4, form resilient expansion tabs 10. In the embodiment shown in the drawings, the part 1 has four longitudinal slots 5 and, correspondingly, four expansion tabs 10. The distance a of the undercut 4 from the open ends of the slots 5 corresponds to form 0.25 to 0.75 times of length l of the longitudinal slots (5), which length is equal to at least five times of the slot width (b).

The shaped part according to the present invention is produced by an injection-molding process. In the first step, the space between an outer mold (not shown) and a chaplet 7, which has a widening section 11 for forming the undercut, is filled with an appropriate material. In a subsequent step, after the outer mold has been removed, a stripping ring 8, which is provided at the end side of the molded part interrupted by open ends of the longitudinal slots 5, is so displaced relative to the chaplet 7, that the shaped part 6 is removed form the chaplet 7 as it is particularly shown in FIG. 3. During the removal process, the expansion tabs are pivoted radially outwardly by the stripping ring 8, freeing the chaplet 7 in the region of the undercut 4. The stripping ring 8 serves as a stop for the part 1. After the shaped part is removed, the expansion tabs 10 return into their rest position shown in FIG. 1.

For forming the undercut 4, the cylindrical chaplet 7 is provided, as it was discussed above, with the widening section 11 that has a triangular cross-section. The triangular cross-section of the widening section 11 provides for formation of a ramp 12 inclined in direction A in which the chaplet 7 is being withdrawn. During stripping of the shaped part from the chaplet 7, the ramp 12 provides for the outward movement of the expansion tabs 12 so that the chaplet 7 becomes free.

Though the present invention was shown and described with references to the preferred embodiment, such are merely illustrative of the present invention and are not to be construed as a limitation thereof, and various modifications to the present invention will be apparent to those skilled in the art. It is therefore, not intended that the present invention be limited to the disclosed embodiment or details thereof, and the present invention includes all of variations and/or alternative embodiment within the spirit and scope of the present invention as defined by the appended claims.

what is claimed is:

1. A shaped part, comprising a hollow cylindrical body (1) having at least two longitudinal slots (5) extending over a larger portion of a longitudinal extent of the hollow cylindrical body (1) and open at one of end surfaces of the hollow cylindrical body (1); and a circumferential undercut formed in an inner wall (3) of the hollow cylindrical body (1) in a longitudinal region thereof intersected by the longitudinal slots (5) and spaced from the one of end surfaces of the hollow cylindrical body (1) by a distance (a), the undercut (4) having a flank (9) tapering toward the one of the end surfaces.

2. A shaped part according to claim 1, wherein the longitudinal slots (5) have a length (1) corresponding to at least five times of a width (b) thereof.

3. A shaped part according to claim 1, wherein the longitudinal slots (5) have a length (1) corresponding at least to an inner diameter of the hollow cylindrical body.

4. A shaped part according to claim 1, wherein the distance, by which the undercut (4) is spaced from the one of the end surfaces of the hollow cylindrical body (1) corresponds to from 0.25 to 0.75 times of a length of the longitudinal slots (5).

5. A shaped part according to claim 1, wherein the part is formed of a high-strength plastic material.

6. A method of forming a shaped part having a hollow cylindrical body (1) having at least two longitudinal slots (5) extending over a larger portion of a longitudinal extent of the hollow cylindrical body (1) and open at one of end surfaces of the hollow cylindrical body (1), and a circumferential undercut formed in an inner wall (3) of the hollow cylindrical body (1) in a longitudinal region thereof intersected by the longitudinal slots (5) and spaced from the one of end surfaces of the hollow cylindrical body (1) by a distance (a), the undercut (4) having a flank (9) tapering toward the one of the end surfaces, the method comprising the steps of inserting, into an outer mold, of a chaplet (7) having a widening section (11) having a shape corresponding to a shape of the undercut (4); filling a space between the outer mold and the chaplet (7) with a material; thereafter, removing the outer mold; and displacing a stripping ring (8), which is provided at the one of the end sides of the hollow cylindrical body (1) and which surrounds the chaplet (7), relative to the chaplet (7) in such a way that the formed shaped part is stripped from the chaplet (7).
